(19) United States
(12) Patent Application Publication
(10) Pub. No.: US 2018/0268489 A1
(43) Pub. Date: Sep. 20, 2018

(54) SYSTEM AND METHODS FOR RISK MANAGEMENT OPTIMIZATION

(71) Applicants: Enda McDonnell, Highland Beach, FL (US); Joseph King, Darien, CT (US)

(72) Inventors: Enda McDonnell, Highland Beach, FL (US); Joseph King, Darien, CT (US)

(73) Assignee: Service First Insurance Group LLC, Jacksonville, FL (US)

(21) Appl. No.: 15/462,635

(22) Filed: Mar. 17, 2017

(51) Int. Cl. G06Q 40/08

(52) U.S. Cl. CPC G06Q 40/08

(57) ABSTRACT

Methods, systems, and apparatus, including computer programs encoded on computer storage media, for processing insurance payments associated with catastrophic events. The system includes one or more processors configured to receive information about a catastrophic event triggering insurance payment along with a deductible payable by the policyholder. The system further includes one or more processors configured to receive information about the policyholder electing to participate in a deductible installment plan, and to advance on behalf of the policyholder of a payment up to the amount of the deductible. A computer record is generated comprising data about the policyholder, the covered property loss, the amount of the deductible, and the repayment schedule. One or more processors are configured to periodically update the record to reflect pertinent insurance deductible payment events, the completion of each step in a sequence of steps associated with payment events in the deductible installment plan. The systems and methods may be risk optimized to reduce insurance payment and deductible costs.

### I. CROSS-REFERENCE TO RELATED APPLICATIONS

Not applicable.

### II. TECHNICAL FIELD

This disclosure relates to risk management optimization generally, and more particularly to systems and methods for reducing the cost of insurance against catastrophic events through separate processing of the insurance policy deductible.

### III. BACKGROUND

One of the principal mechanisms to protect against catastrophic events in the future is to secure an insurance policy covering such events. A typical insurance policy is a contract between an insurer and the insured, known as the policyholder, which contract determines the claims that the insurer is legally obligated to pay upon the occurrence of a covered event. In exchange for one or more payments, known as premiums, the insurer promises to pay for damages caused by an event covered under the policy language. While parties who may need protection against future events typically are not required to purchase insurance or, even if insured, to pay the premiums, the insurer is required to pay the benefits under the contract if the insured has paid the premiums and has met certain other policy provisions. A typical insurance policy identifies the policyholder(s), their address, the insuring company, what risks or property are covered, the policy limits (amount of insurance), any applicable deductibles, the policy period and premium amount(s).

It should be apparent that events covered under insurance policies are inherently uncertain. The uncertainty can relate to when a covered event will happen (such as death in the case of a life insurance policy), or whether the covered event will happen at all, as in a typical property insurance. For example, a property and casualty insurance policy deals with the uncertainty as to whether or not a covered event, such as a fire, hurricane, tornado or earthquake will occur during the term of the policy.

Insurance contracts are designed to meet specific needs and deal with a range of uncertain situations, from frequently occurring to unusual and from covering events that may cause relatively small damage to events that may result in catastrophic damage. For example, property and casualty insurance is a form of property insurance that pays the policyholder (or on behalf of the policyholder) for insured damages in the event of a hurricane that may cause massive damage to the property. Most ordinary homeowner insurance policies in hurricane prone regions cover wind (and thus hurricane) damage and, dependent on where the property is located, the owners may never have a reason to collect under the insurance policy. But over time insured property catastrophes happen and, given the substantial damages associated with catastrophic events, under the right circumstances an appropriate insurance policy can be extremely beneficial in returning the insured to the financial position they were in, minus their deductible, prior to the catastrophe occurring.

Many insurance policies covering catastrophic events such as hurricanes, earthquakes or tornadoes, feature a high deductible. From the standpoint of the policyholder this makes such insurance extremely valuable if an entire home or most of it is destroyed, but less so if the home merely suffers peripheral damage. Of course, no one can predict the damage to a particular home which stands in the path of a hurricane or a tornado. This additional uncertainty highlights the importance of selecting an appropriate deductible. In a property insurance policy, the deductible is the amount that must be paid out of pocket by the insured before an insurance company (hereafter “Insurance Company” or “IC”) will pay to repair the property. In general, the term deductible is used to describe a dollar amount threshold, the crossing of which triggers policy payments. Deductibles are normally provided as clauses in an insurance policy that dictate how much of an insured loss is paid by the policyholder before insurance coverage kicks in. Thus, the insurer is liable for covered losses that exceed the amount of the deductible (subject to a maximum sum stated in the contract). Depending on the policy, the deductible may apply per covered incident, or per discrete time period, usually a year.

Deductibles are typically used to deter claims for amounts that policyholders can be reasonably expected to bear on their own. By restricting its coverage to events that are significant enough to incur large costs, insurance companies expect to pay out smaller amounts less frequently. As a result, insurance premiums are typically cheaper when the underlying policies have higher deductibles.

Deductibles can be set by the insurer to differ based on the cause of the claim. For example, a single homeowner's insurance policy may contain multiple deductible amounts for loss or damage arising from theft, fire, evacuation, hurricane, etc. The amount of the deductible in turn helps determine the corresponding insurance premium rates, which in addition may depend on the location, the probability of a covered event (especially if catastrophic), the features of the covered property, and other factors, some of which are discussed below. Sophisticated mechanisms are available to compute the applicable premiums, which may be assessed using a collection of mass inventory data, experts' opinions, or other factors such as the ratio of the expected damage amount to the total value of an insured property. Broadly speaking, premiums are based on the estimated losses associated with a covered event in a particular place and the policy deductible.

From a public policy perspective, carrying property insurance helps individual policyholders as well as the community at large to recover quickly after a catastrophic event. It is thus in everyone's interest to have a well-functioning insurance market where upon a catastrophic event insurance proceeds can be quickly deployed to mitigate and repair the resulting damages. At the present time, however, there are concerns that have not been adequately addressed.

For example, a serious concern about the efficient use of present insurance policies against catastrophic events is the ability of the insured to cover the deductible upon occurrence of such an event. As noted above, to minimize premiums some policyholders choose a high deductible which they may not be able to cover precisely when it is needed. According to a 2016 study by the Economic Policy Institute, nearly half of the families in the United States have no retirement account savings at all; the median savings of a family with members between ages 32 and 37 is less than $500, for those aged between 56 and 61 the median is $17,000. See http://www.cnbc.com/2016/09/12/heres-how-much-the-average-american-family-has-saved-for-retirement.html. In short, following a catastrophic event, a number of home owners may not be able to recover quickly if they are unable to pay the deductible, or may take a long time after the event to come up with the funds and pay the deductible. Consequently, repairs to the damaged property will be delayed for the period of time it takes the policyholders to come up with funds to cover the deductible and may result in additional weather-related or other damages to the covered property and/or associated costs. It will thus be appreciated that the inability to put insurance money to use quickly following a catastrophic event will result in additional insured losses which in turn result in future premium charges. For example, the longer the repair work is delayed following a covered catastrophic event, the more expenses will be incurred to pay the policyholder's stay at a hotel, increasing the cost to the insurance company (and the corresponding premiums in the following insurance periods).

Additional concerns for the insurance companies are due to the likelihood of fraud in the estimate of the incurred damage. Indeed, one of the most common forms of insurance fraud is believed to be inflating the value of the loss. For example, unscrupulous contractors may artificially inflate the cost of repairs for damage caused by a particular event so as to either exceed the deductible amount of an insurance policy (thus helping the policyholder), to get paid over and above the work needed to fix the actual damage, or both. Insurance fraud of this type is difficult to detect and combat, and causes everyone's insurance rates to be higher than if this fraud did not take place.

The present disclosure is intended to address the above and other deficiencies associated with the prior art.

### IV. SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one aspect, described is a method for processing payments for a deductible amount under a property insurance policy, comprising the steps of: (a) receiving an indication that a property insurance policyholder has elected to use a deductible installment plan (DIP) upon the occurrence of a covered event that triggers a deductible payment by the policyholder; (b) creating a computer record comprising data about the policyholder, data about a covered property insurance loss, and an insurance policy deductible amount; (c) updating the created computer record to reflect a deductible payment date and a deductible amount advanced on behalf of the policyholder, the advanced deductible amount being based on one or more of the insurance policy deductible amount, an amount specified in the DIP, or an amount selected by the policyholder that is less than the insurance policy deductible; and (d) updating the created computer record to track one or more repayments made by the policyholder under the DIP to cover the advanced deductible amount.

In specific embodiments, the described method comprises DIP schedule for deductible repayment that provides for billing the policyholder for repayment amounts in two or more pre-specified intervals, and specifies that a first repayment by the policyholder becomes due at a given point in the future, such as three or six months after the date of the deductible amount advance. In a preferred embodiment the property insurance policy is for protection against damages caused by a catastrophic event, such as a hurricane or a tornado, and may include additional steps of verifying the occurrence of an event that triggers a deductible payment by the policyholder, and/or verifying the eligibility of the policyholder to participate in the DIP.

In additional specific embodiments, the disclosed method further comprises the steps of (e) comparing instances of insurance payments on insurance policies covering substantially similar triggering events, where the payments were handled with a DIP and without DIP payment processing; and (f) adjusting premiums for insurance policies covering substantially similar triggering events on the basis of the results of the comparison in step (e).

In another embodiment, disclosed is a computer system for managing payments under an insurance policy with a deductible, the computer system comprising: one or more servers for communicating with policyholders over a communications network; a processing service system, the system being configured to create one or more computer records, each computer record comprising data about a policyholder who has elected to participate in a deductible installment plan (DIP), and an amount of a covered property insurance loss claimed by the policyholder; a computer memory communicatively coupled to the processing service system for storing one or more computer records, and wherein the processing service system is further configured to update a created computer record to reflect a deductible amount advanced on behalf of the policyholder and to track one or more repayments made by the policyholder under the DIP to cover the advanced deductible amount.

In specific embodiments the computer system may further comprise one or more of (1) an analytics engine communicating with said processing service system and said memory, the analytics engine configured to computer statistical data concerning computer records for different policyholders; (2) a risk engine configured to process computer records to identify trends in insurance claims processing events that indicate a heightened risk of fraud; or (3) a settlement engine configured to process payment events in accordance with a DIP schedule. In embodiments, computer records further comprise deductible payment date and a DIP schedule for one or more deductible repayment dates and amounts

Additional aspects are provided in the drawings and the following detailed disclosure.

### V. BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 is a diagram of the principal entities in a catastrophic event insurance processing including a deductible installment plan;

FIG. 2 is a schematic illustration of the architecture of an example computer processing system used in one embodiment.

FIG. 3 is a high-level processing diagram illustrating the process by which according to one embodiment an insurance policyholder may pay a policy deductible after a covered loss over a term that exceeds the policy period.

Throughout the drawings and the detailed description, unless otherwise described, the same drawing reference numerals will be understood to refer to the same elements, features, and structures. The relative size and depiction of these elements may be exaggerated for clarity, illustration, and convenience.

### VI. DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses and/or systems described herein will be suggested to those of ordinary skill in the art. Also, descriptions of well-known functions and constructions may be omitted for increased clarity and conciseness.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “large,” “small,” “catastrophic” are used in the description for clarity and, where not defined, are not intended to limit the scope of the invention or the appended claims. Further, it should be understood that any one of the features can be used separately or in combination with other features. Other systems, methods, features, and advantages of the invention will be apparent to one with skill in the art upon examination of the detailed description. It is intended that all such additional systems, methods, features, and advantages be included within this description, be within the scope of the present invention, and be protected by the accompanying claims.

A. Principal Players

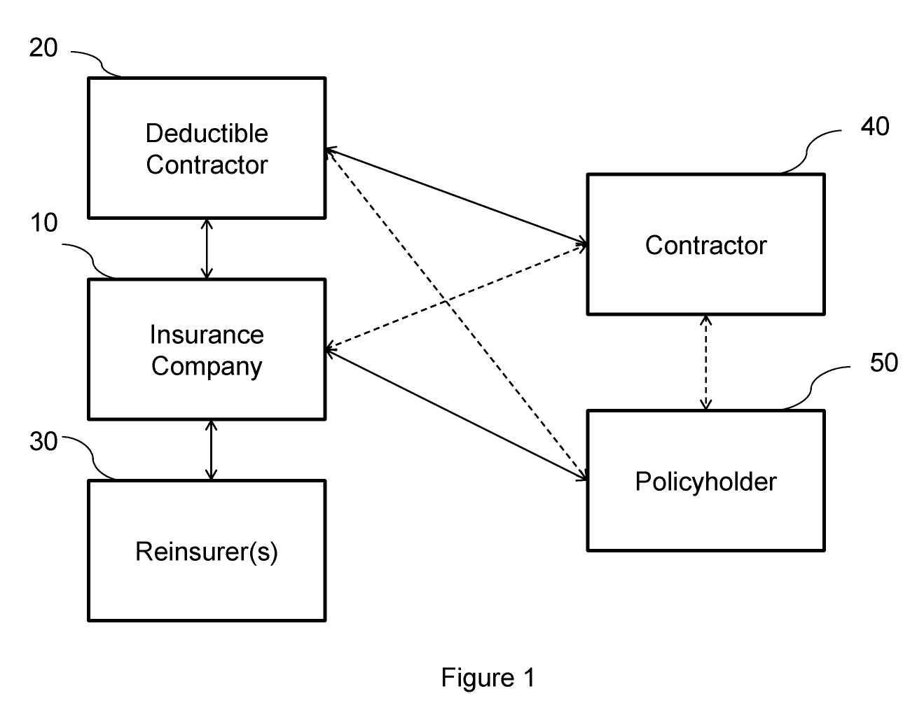

FIG. 1 is a diagram of the principal entities in a catastrophic event insurance processing including a deductible installment plan (DIP) in one embodiment. As used in this disclosure and explained in further detail below, DIP will refer to a mechanism for processing a deductible in an insurance policy, where upon the occurrence of a triggering event that deductible does not have to be paid by the policyholder upfront. Rather, an amount up to the deductible is advanced on behalf of the policyholder and subsequently the advanced amount is repaid by the policyholder over a period of time in accordance with a particular schedule. Referring back to FIG. 1, as known in the art, the principal relationship is between an insurance company (“Insurance Company” or “IC”) 10 and one or more policyholders 50. It will be appreciated that when providing insurance on covered damage from catastrophic events, such as a hurricane, tornado or other large-scale disasters, insurance companies 10 must be careful, because a natural event strong enough to destroy one home will likely destroy dozens of homes in the same area. If insurance company 10 has written insurance policies on a large number of homes in a particular area, then a devastating event may drain all the company's resources. One mechanism for dealing with this potential problem is through reinsurance provided by one or more reinsurers 30, as shown in FIG. 1.

Reinsurance is insurance that is purchased by an insurance company (the “ceding company”) from one or more reinsurance companies (the “reinsurer”) directly or through a broker as a means of risk management. The ceding company and the reinsurer enter into a reinsurance agreement which details the conditions upon which the reinsurer would pay a share of the claims incurred by the ceding company. The reinsurer is paid a “reinsurance premium” by the ceding company (IC 10), which issues insurance policies to its own policyholders. A healthy reinsurance marketplace helps ensure that insurance companies can remain financially viable, particularly after a major disaster such as a hurricane, because the risks and costs are spread. It will be appreciated that in embodiments reinsurer(s) 30 need not necessarily be used.

Also shown in FIG. 1 is a deductible contractor (“DC”) 20, which may be a legally separate entity specifically handling deductible payment processing. In an alternative embodiment, deductible contractor 20 may be subsumed by the insurance company 10 or an affiliated part thereof (thus DC 20 may merge into IC 10 in embodiments).

Also shown in the diagram in FIG. 1 is a contractor 40, an entity approved to handle repairs for damages caused by the catastrophic event. In one embodiment, an amount up to the entire policy deductible is advanced on behalf of the policyholder 50 to contractor 40. Such an arrangement may minimize the potential for fraud on the Insurance Company 10 and may also help ensure that work on repairing the damage is done at the earliest time and to approved standards. As illustrated with dotted lines in the drawing, dependent on the particular arrangement, the deductible contractor 30 may communicate with the contractor 40 directly or indirectly through the policyholder. Likewise, IC 10 can communicate either directly or indirectly with the contractor or the policyholder in connection with processing the deductible payments. The use of solid or dotted lines in FIG. 1 is for illustrative purpose only; in different embodiments communications can be arranged in the appropriate manner.

B. Computer Processing System

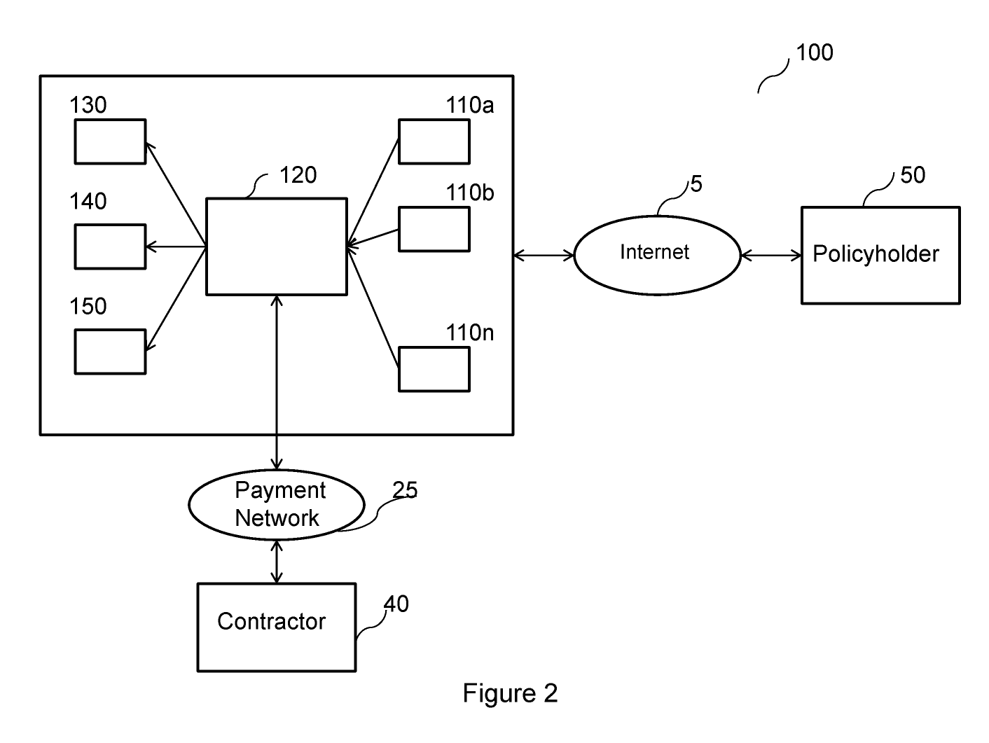

FIG. 2 is a schematic illustration of the architecture of an example computer processing system 100 used in one embodiment. The overall system 100 includes policyholder 50 communication devices and an Insurance Company 10 processing service system that are interconnected by a communications network, such as the Internet 5. Policyholder 50 communications devices can be a mobile computing device capable of running software applications, such as a smartphone or tablet. These devices can also be a desktop computer, a laptop computer, or other data processing apparatus. In alternative embodiments, communication with the policyholder can be done over a phone or by regular mail.

The processing service system at the Insurance Company 10 includes a processing service system 120 that communicates with the policyholders 50 using the communications network 5. The processing service system includes one or more servers 110a, b, n. Preferably, at least some of these servers can handle secure transactions (e.g., using a secure server), to process transactions with the policyholder(s) 50. The servers 110x may also be configured to handle secure information such as credit card numbers, debit card numbers, bank accounts, policyholder identifying information or other sensitive information.

To initiate an insurance claim request, the policyholder 50 provides an insurance request to one of the servers 110. When an insurance claim request is approved (as discussed below) the processing service system 120 may communicate back to the policyholder 50, and/or directly with a computer system at the Contractor 40 using a payment network 25. The processing service system 120 can communicate with Contractor 40 over the Internet 5 which is typically used to communicate with the policyholders 50, or over a different network. The computer system at the contractor can communicate in turn with a computer system of a card issuer, e.g., a bank (not shown). It will be appreciated that in different embodiments there can also be computer systems of other entities. For example, with reference to FIG. 1, the processing service system 120 may be implemented at a facility operated by Deductible Contractor 20.

Servers 110x can generally associate the steps of a particular insurance claim transaction with a transaction identifier and store those in a computer memory. The servers 110x can generate a unique transaction identifier for each new transaction requested by a policyholder, e.g., for each insurance claim received from the policyholder 50. In an embodiment, the servers may generate a computer record comprising a variety of data points including, for example: data about the policyholder and the insurance policy, the covered property insurance loss, payment date, payment amount, and schedule for one or more repayment date and amounts), as explained in more detail below. In specific embodiments the computer record may comprise other information, such as (a) the location of and the specific kind of loss along with a description of any kind of loss and damage; the probable amount of the entire loss; the police or fire department to which loss was reported (for verification purposes); (b) policy information, including its effective and expiration date(s), any dwelling, other structures, personal property, loss of use, deductible(s) and additional coverages provided, and whether or not the policy is active; (c) any state-specific information, such as statements or data that are mandatory for the state where the property is located including, for example, acknowledgement that a knowing submission of a false or fraudulent claim is a crime and may result in fines or prison term; (d) routing information, including the identity of the agent(s) to whom the claim was assigned; (e) interview question and answer section, such as whether or not the policyholder feels safe and able to stay in their home at the time the event is reported, whether or not emergency clean up services are needed; whether or not anyone has been contacted to begin the cleanup or repairs; (f) the identity of a deductible contractor, if any, and or the listing of contractors approved by the insurance company for repair work; and (g) miscellaneous other information. The processing service system 120 can index such computer records by transaction identifiers, policyholders, or any of the above-identified data items, as known in the art. Servers 110x can then determine the status of a particular transaction by referencing a transaction identifier for the transaction, or using another suitable index associated with the generated computer record. It will further be appreciated that while the computer records are described as being created by the servers 110x, in alternate embodiments they can be created by the processing service system 120. It will further be appreciated that the records can be stored locally in a computer memory associated with the processing system, remotely or be distributed on the cloud.

Referring back to FIG. 2, based on the information in the created computer record, the processing system can generate payment events, each representing a particular step of an insurance claim processing transaction. For example, payment events can include an authorization, a capture, a void, or a refund for a particular transaction being requested. It may reflect transactions being routed to or received from an entity, failing, or encountering other kinds of errors. For example, transaction events can include (1) submission of claim to insurer, (2) review of applicable policy coverage, (3) claim reserving, (4) inspection of property, (5) additional investigation activities, (6) estimate of damages, (7) payment of claim, (8) denial of claim, (9) repair of property, (10) dispute resolution activities, (11) final settlement of claim, (12) claim recoveries, (13) initial statutory claim reserving, (14) changes to statutory claim reserves, (15) statutory reserve approvals, (16) closing statutory reserves, (17) payment entry, (18) payment issued, and (19) payment void or cancelled. Other types of events can also be used as known in the art.

Various events generated by the processing system in the course of processing an insurance claim can be provided to, and analyzed by several back end processing engines in different embodiments. With reference to FIG. 2, such back end processing engines are “back end” in the sense that the flow of a claim processing and payments need not depend on these processing engines. Rather, it will be appreciated that the processing engines can access events handled by the Insurance Company 10 both individually or in the aggregate, and perform calculations asynchronously from the actual transactions.

For example, an analytics engine 130 can process insurance processing events to compute different statistics, for example, gross monthly claims processed, average claim requests per policyholder, percentage of claims that involve the use of deductible installment plans (described below), average time to process insurance claims that relate to a single catastrophic event, and others. A risk engine 140 can process events to identify trends in insurance claims processing events that indicate a heightened risk of fraud. For example, amounts for damages from different policyholders in an single area affected by a catastrophic event can be compared to identify significant statistical deviations, and the engine can flag instances of potential insurance fraud. Likewise, historical data can be used to identify policyholders that present potential risk of asserting inflated (or false) claims. A settlement engine 150 can process payment events to finalize complete insurance processing transactions. Other kinds of back end processing engines can also be implemented dependent on particular needs. For example, a backup processing engine can request information from the processing event feed, and distribute the collected information to geographically diverse sites. Such reconciled and redundantly stored events data can be used to keep multiple sites synchronized and ready for independent use in case of disaster recovery. In a specific embodiment, the settlement engine 150 can be used to estimate the savings realized by the Insurance Company 10 from the use of the deductible installment plan described below.

The back end processing engines may be implemented on appropriate types of computing devices that typically include one or more processors and computer readable media. As used in this specification, an “engine” or “software engine,” refers to a software implemented input/output system that provides desired output based on given input information. Such an engine can be a software block of functionality, such as a library, a platform, or an object. Engines can be implemented on any appropriate type of computing device, including servers, tablets, notebook computers, laptop or desktop computers, PDAs, smart phones, or other stationary or portable devices that include one or more processors and computer readable media. It will be appreciated that two or more of the engines may be implemented on the same computing device, or on different computing devices.

In some cases, inconsistencies may arise for processing events belonging to a particular transaction. Inconsistencies can arise for various reasons, including human errors at both the policyholder 50 and Insurance Company 10 (or deductible contractor 20), malfunctioning software, or other errors. Accordingly, as part of generating the computer record feed the processing service system 120 can access the events of a particular insurance claims (or more granularly to a particular transaction) by referencing a computer record or a transaction identifier. The processing service system 120 can then reconcile any inconsistencies, and generate processing event feed using the reconciled information and associated event identifiers. Like the back end processing engines, processing service system 120 can be implemented on any appropriate type of computing device that includes one or more processors and computer readable media.

C. Processing Algorithm

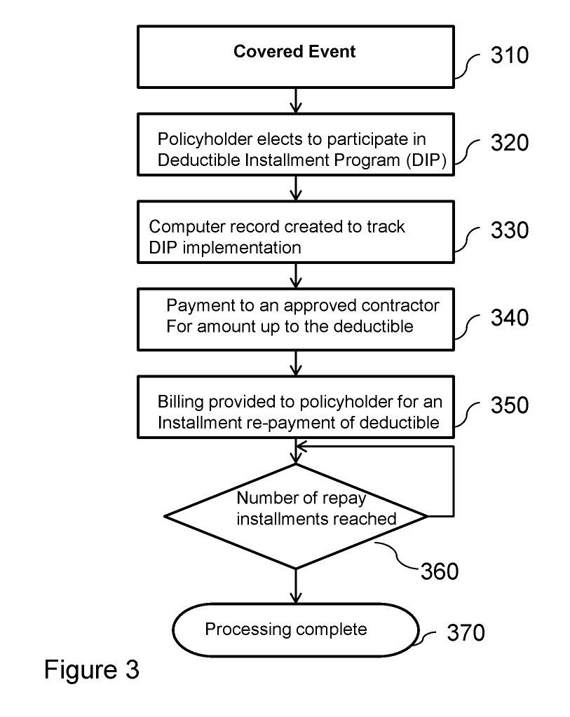

FIG. 3 is a high-level processing diagram illustrating the process by which according to one embodiment an insurance policyholder may pay a policy deductible after a covered loss over a term that exceeds the policy period.

The processing algorithm is initiated at step 310 when a covered property insurance loss occurs that triggers a deductible payable by the policyholder. At this point, the policyholder 50 would communicate with the Insurance Company 10 about the event. With reference to FIG. 2, the communication may occur over the Internet 5, by phone or via other means that are acceptable as per the language of the insurance policy. In a typical implementation, the system verifies that a covered event has indeed occurred. For example, in the context of processing a claim under a homeowners insurance policy that protects against damage from the peril of wind, the policy may require independent verification of the event using one or more sources, such as the National Hurricane Center, operated by the National Oceanographic and Atmospheric Administration; the corresponding State Office of Insurance Regulation, or IC 10 itself.

In the following step 320 the policyholder 50 communicates its request to use a Deductible Installment Plan (“DIP”) offered by the Insurance Company 10 in association with an authorized Deductible Contractor 20. This processing step may require verification if the policyholder qualifies for, or has been extended an offer to participate in the DIP. Care must be taken to ensure that no insurance fraud can be committed, for example, through processing of a request from policyholders that are not otherwise eligible to participate in the DIP. It will be appreciated that in embodiments where the Insurance Company 10 also manages the DIP, participation in the plan may be specified in the body of the insurance policy and as a result policyholders may automatically qualify for the plan. In such case, if the policyholder is current on insurance premium payments, that policyholder is also eligible for the DIP assuming a covered loss occurs. In the process of handling the initial covered catastrophic event claim the policyholder may be offered the option to participate in the DIP if they didn't already choose to do so when the policy was purchased, and may indicate an election to do so as part of the initial communication reporting the claim. Policyholder 50 may also elect to not participate in the DIP, in which case processing the insurance claim is handled as per ordinary business practices. Alternatively, the policyholder may also specify the amount of the deductible he or she wishes to have advanced on their behalf as part of the election to participate in the DIP. In other words, in the step of electing to participate in the DIP, the policyholder may also be asked to request the specific amount (or percentage) of the policy deductible to be advanced.

In the alternative, where the DIP is managed by a legally separate entity, designated herein as Deductible Contractor (DC) 20, election to participate in the plan may be made part of a separate communication with the policyholder, which communication may be initiated either directly by DC 20 or by the Insurance Company IC 10 on behalf of the DC 20 in different embodiments. The specifics of the policyholder's DIP election are within the scope of understanding of a person of ordinary skill in the art, and will not be discussed in further detail.

Back with reference to FIG. 3, once the policyholder has elected to participate in the DIP, in the following step 330 a computer record is created by a processing server 110x (or processing system 120) to track any of the details discussed above including, for example, the policyholder, the loss, payment date, payment amount and schedule for repayment dates and amounts in accordance with the provisions of the DIP applicable to the policyholder. The created record is stored in a computer memory and, as necessary, replicated to different locations for disaster recovery purposes. It will be appreciated that processing the details of the deductible installment plan can be done in different embodiments in parallel with, or as part of the standard mechanism for processing insurance claims.

In the next step 340, in accordance with the provisions of the DIP applicable to the individual policyholder, a payment is made on behalf of the policyholder by the Insurance Company 10 or the Deductible Contractor 20, as the case may be. In a preferred embodiment, the payment is made directly to an approved Contractor 40 for up to the amount of the deductible in the insurance policy, or an amount that the policyholder has requested as part of the DIP election. As explained earlier, the early payment of the deductible and the use of approved contractors has the added benefit of reducing the cost of repairing damages associated with a catastrophic event. In the same step, the computer record corresponding to the policyholder is updated to track amount, payment details, transaction date and other pertinent information.

In step 350, billing is provided to the policyholder for an initial amount of repayment according to the provisions of the DIP in which the policyholder elected to participate. In a specific implementation, the first installment in the DIP repayment plan is made due six months from the date payment was made to the authorized contractor. Shorter or longer periods may be used for the initial payment as deemed appropriate by the Insurance Company 10 or the Deductible Contractor 20 in different embodiments. The computer record is updated to reflect the repayment information including all elements of the transaction.

The following step 360 repeats the processing of the repayment obligations by the policyholder based on the schedule specified in the DIP. In particular, the Insurance Company 10 or the Deductible Contractor 20 generate an invoice to policyholder for the next deductible repayment installment. The computer record in the system is updated to reflect the updated invoice and payment details. In a preferred embodiment, there is no early payment penalty, allowing the policyholder to fully satisfy its repayment obligations ahead of the schedule specified in the DIP.

Once the payment schedule according to the DIP (or the actual payments made by the policyholder) is completed, and all payments are received, the computer record for the particular policyholder and insurance claim is updated and the record is closed. In a particular embodiment, repayment may be expected after two and a half years, however different terms that may be shorter or longer can be used in general.

It will be appreciated that the repayment of the deductible under the DIP can be made on a schedule, such as two and a half years, that allows flexibility for the policyholders to deal with catastrophic events that may otherwise significantly affect their ability to deal with the associated damages. This flexibility allows not only individual members, but entire communities affected by the effect to recover much more quickly. The insurance companies in turn have the potential to reduce the overall money outlays, and ultimately even reduce insurance premiums for participating policyholders. It will also be appreciated that the processing method in a specific embodiment may include a further step (not shown) of communicating with reinsurer(s) 30, if the scope of the damaged area (and correspondingly the number of claims) is sufficiently large. In a specific embodiment, handling the DIP may be subject to its own reinsurance policy, as needed.

The potential for savings using the methods and systems described herein can be quantified with reference to different categories of expenses and costs normally associated with catastrophic events. For example, such categories of savings can include (1) additional living expenses; (2) reduction in the deterioration of the condition of the property after a covered loss, (3) reduced loss adjustment expenses, and others.

In the above example, as to category (1) an insurer that protects an insured against damage to their home from a covered peril is usually required to pay the additional living expense that an insured (and family living with them) incurs after a covered loss. This includes hotel expenses; rent etc. The starting cost for these items may be $200 per claim per day and can go higher than $500 per day per claim that the insured is out of their home. Through the use of a Deductible Installment Plan, the insured will be able to allow repairs to commence on their home much quicker than if they had to come up with the deductible beforehand and wait for the contractor to receive their payment for the deductible. As the insurance company (or Deductible Contractor) is advancing the deductible on behalf of the policyholder, the contractor will be willing to start the repairs quickly, without waiting for the insured to come up with the payment or for any check written by the insured to clear. The estimated savings in the number of days that the insured is out of the home ranges from 2 days to 20 days. Translating this into dollar savings for the insurance company results in savings ranging from a minimum of $400 to $10,000 per claim. Elimination of an average delay of about 10 days translates into average savings of about $3,000.

As to category (2), it will be appreciated that a property is exposed to deterioration in its condition after a covered loss. For example, a home with its roof half torn off is susceptible to additional damage resulting from rain/water coming through the opening in the roof. Additionally, in hot and humid climates, the additional moisture may contribute to the growth of mold or cause damage to additional contents in the property. The cost to repair these damages increases rapidly the longer the delay in mitigating the loss and starting the repairs. Using a Deductible Installment Plan disclosed herein allows for the mitigation and repair work to commence immediately (as the contractor knows that they will get paid) thereby reducing the cost of deterioration in the condition of the covered property after a loss. Estimated savings per claim with immediate mitigation and repair range from $1,000 to $10,000 depending on the severity of the covered loss with an estimate of average savings per claim being about $3,000 in a catastrophic claim.

As to category (3), it will be appreciated that there are costs associated with investigating and adjusting losses. These are called Loss Adjustment Expenses (“LAE”). These costs include experts and attorneys if the claimant is represented by an attorney. The longer the time from the date of the loss occurrence to the start of the repair process, the greater the chance of a third party, such as an attorney, will get involved. The claim cost to open a single file with an attorney to represent an insurance company in each claim usually starts at $5,000. The usual result of attorneys becoming involved results in the claims process slowing down. This further increases the costs resulting from additional living expenses and deterioration in the condition of the property which drives up the cost of the claim further. The estimated savings in LAE from using a Deductible Installment Plan as disclosed herein ranges from $1,000 to upwards of $50,000 per claim with the average being more than $2,000 per claim in a catastrophic loss.

Overall, the average savings to the Insurance Company from using a Deductible Installment Plan is estimated to range from $2,400 to more than $60,000 per claim. As shown above, the average savings realized by the Insurance Company per claim related to a catastrophic event are estimated to be about $8,000. Multiplying this cost saving estimate by the number of claims involved in a large catastrophic loss (e.g. a hurricane) will result in savings of many millions of dollars. Insurance industry statistics indicate that approximately 4% of home insurance policies will experience a catastrophic loss once every seven years. The annual average per policy savings is estimated therefore as $45.71 ($8,000 in expected savings, divided by 7 and multiplied by 4%). The above numbers are illustrative only, and can change with the accumulation of historical data. The data is likely to become more reliable and structured, dependent on the type of catastrophic event, the location, and other variables. It will be appreciated, however, that regardless of how the data works out over time, assuming the use of a Deductible Installment Plan as disclosed herein, both the Insurance Company 10 and the policyholder 50 will likely realize substantial savings.

D. Example Deductible Installment Plan

Following is an example deductible installment plan (DIP), that may be used in an embodiment as part of a catastrophic event insurance policy.

Deductible Advance for Losses Caused by a Hurricane.

We will offer to provide a Deductible Advance to cover X % of the Coverage-A limit for a covered loss caused by a Hurricane, as defined below. We shall not provide the Deductible Advance for any other covered loss.
The Deductible Advance will be an amount equivalent to the lesser of the policy deductible or X % of the Coverage-A limit.
The Deductible Advance shall be repaid to the [Insurance Company] over a period of up to W years. The Insurance Company will bill you in Y equal installments. The first installment will be billed not earlier than Z calendar months from the date of the Company's Deductible Advance payment to You. The second installment will be billed XX months after the first installment was billed. The third installment will be billed YY months after the first installment was billed. The bills for each installment shall be due within 30 calendar days from the date of being billed. You may pay any part of the unpaid Deductible Advance at any time with no penalty to you. The Company will not charge You any fees or interest from your use of the Deductible Advance.
Should You not pay any installment, the Company may take action adverse to your interests to recover the unpaid amounts, including:
Non-renewing your policy for failure to comply with your obligations under the policy;
Using third-parties to collect the unpaid deductible installment; and
Taking such other efforts as may be lawful to collect an unpaid, unsecured debt.
The Company will not place a lien on your real property for the Deductible Advance amount.

Hurricane means an event which:
Is declared a hurricane by the National Hurricane Center, operated by the National Oceanographic and Atmospheric Administration; or
Is determined to be a hurricane by the Florida Office of Insurance Regulation; or
Is determined to be a hurricane by Property Claims Services, a unit of Insurance Services Office, Inc.; or
Is determined to be a hurricane by the Company.

It will be appreciated by those skilled in the art that changes could be made to the embodiments described above without departing from the inventive concept. For example, the DIP can be managed in a manner that requires the policyholder to use the deductible advance to make a payment to a contractor to commence, continue, and/or complete repairs. Prudent practice may provide that advancement may be restricted and made available only when a contractor approved by Insurance Company 10 commences, continues, and completes repairs. Specifically, the Insurance Company may require as part of the DIP that if an unapproved contractor commences, continues, or completes repairs on behalf of the policyholder, or if that policyholder assigns benefits under the DIP to a third party without the IC 10 consent, the Insurance Company will have no obligation to make a deductible advance. These and other measures can be taken in the process of managing the DIP to minimize the potential for insurance fraud, and make the best use of the available deductible advance funds. In alternative embodiments, the DIP may include different repayment schedules, which the policyholders may select from dependent on their individual needs.

It will be appreciated by those skilled in the art that changes could be made to the embodiments described above without departing from the inventive concept thereof. It is understood, therefore, that the invention disclosed herein is not limited to the particular embodiments disclosed, and is intended to cover modifications within the spirit and scope of the present invention, which is defined in the attached claims.

What is claimed is:

1. A method for processing payments for a deductible amount under a property insurance policy, comprising the steps of:
(a) receiving an indication that a property insurance policyholder has elected to use a deductible installment plan (DIP) upon the occurrence of an event that triggers a deductible payment by the policyholder;
(b) creating a computer record comprising data about the policyholder, data about a covered property insurance loss, and an insurance policy deductible amount;
(c) updating the created computer record to reflect a deductible payment date and a deductible amount advanced on behalf of the policyholder, the advanced deductible amount being based on one or more of the insurance policy deductible amount, an amount specified in the DIP, or an amount selected by the policyholder that is less than the insurance policy deductible; and
(d) updating the created computer record to track one or more repayments made by the policyholder under the DIP to cover the advanced deductible amount.

2. The method of claim 1 wherein the DIP includes a schedule for deductible repayment, the schedule providing for billing the policyholder for repayment amounts in two or more pre-specified intervals, and the first repayment by the policyholder becomes due at least six months after the deductible payment date when the deductible amount was advanced.

3. The method of claim 1, wherein processing steps (a)-(d) are performed by the insurance company that issued the property insurance policy.

4. The method of claim 1, wherein processing steps (a)-(d) are performed by a party other than the insurance company that issued the property insurance policy.

5. The method of claim 1, wherein the property insurance policy is for protection against damages caused by a catastrophic event, such as a hurricane or a tornado.

6. The method of claim 1, wherein step (a) further comprises the step of receiving third party information about a covered property insurance loss that triggers a deductible payment by the policyholder, and verifying the eligibility of the policyholder to participate in the DIP.

7. The method of claim 1, wherein in step (c) the amount advanced on behalf of the policyholder is provided directly to a contractor handling repairs for damages associated with the triggering event.

8. The method of claim 5, wherein provisions of the DIP are included in the property insurance policy.

9. The method of claim 1, further comprising the steps of
(e) comparing instances of insurance payments on insurance policies covering substantially similar triggering events, where the payments were handled (i) with a DIP and (ii) without a DIP payment processing; and
(f) adjusting premiums for insurance policies covering substantially similar triggering events on the basis of the comparison in step (e).

10. The method of claim 9, wherein step (e) of comparing is based on examination of one or more updated computer records.

11. The method of claim 1, wherein the computer record is stored in a computer memory accessible to the operator of the DIP.

12. A computer system for managing payments under an insurance policy with a deductible, the computer system comprising:
(a) one or more servers for communicating with policyholders over a communications network;
(b) a processing service system, said system configured to create one or more computer records, each computer record comprising
data about a policyholder who has elected to participate in a deductible installment plan (DIP), and
an amount of a covered property insurance loss claimed by the policyholder;
(c) a computer memory communicatively coupled to the processing service system for storing created computer records, and
wherein the processing service system is further configured to update a created computer record to reflect a deductible amount advanced on behalf of the policyholder and to track one or more repayments made by the policyholder under the DIP to cover the advanced deductible amount.

13. The computer system of claim 12, wherein the communications network is the Internet.

14. The computer system of claim 12, further comprising an analytics engine communicating with said processing service system and said memory, the analytics engine configured to compute statistical data concerning computer records for different policyholders.

15. The computer system of claim 14, wherein the statistical data concerning computer records includes one or more of: gross monthly claims processed, average claim requests per policyholder, percentage of claims that involve the use of DIP, and average time to process insurance claims that involve the use of DIP.

16. The computer system of claim 12, further comprising a risk engine configured to process computer records to identify trends in insurance claims processing events that indicate a heightened risk of fraud.

17. The computer system of claim 12, further comprising a settlement engine configured to process payment events in accordance with a predetermined DIP schedule.

18. The computer system of claim 12, further comprising a backup processing engine configured to distribute information contained in created computer records to geographically diverse sites.

19. The computer system of claim 12, wherein each computer record further comprises deductible payment date and a DIP schedule for one or more deductible repayment dates and amounts.

20. The computer system of claim 12, wherein the processing service system is configured to compute insurance policy premium savings based on examination of computer records for policyholders who elected to participate in a DIP.
